(19) United States
(12) Patent Application Publication
(10) Pub. No.: US 2013/0059330 A1
(43) Pub. Date: Mar. 7, 2013

(54) FIXING SOLUTION FOR BIOLOGICAL CELLS

(71) Applicant: Eric Peltier, Clamart (FR)

(72) Inventor: Eric Peltier, Clamart (FR)

(73) Assignee: Novacyt, Velizy Villacoublay (FR)

(21) Appl. No.: 13/575,325

(22) PCT Filed: Jan. 20, 2011
(86) PCT No.: PCT/FR2011/050101

§ 371 Date: Oct. 17, 2012

(30) Foreign Application Priority Data
Jan. 27, 2010 (FR) 10 50536

(51) Int. Cl. G01N 1/30

(52) U.S. Cl. 435/40.5

(57) ABSTRACT

This fixing solution is intended to preserve in vitro a cytological sample, comprising nucleated cells and erythrocytes and comprises alcohol for fixing the cells. It comprises physiological saline in order to avoid osmotic shocks at the wall of the cells, formalin and polyethylene glycol for retaining the size and the integrity of the nucleated cells and erythrocytes, which are fixed in said solution.

The solution does not contain acetone or any compounds of the ketone or acetic acid family.

The present invention relates to a fixing solution for biological cells intended to preserve in vitro a cytological sample, of the type comprising alcohol for fixing the cells. The invention more particularly applies to the field of cytology.

Fixing solutions or fixatives are provided for preserving and keeping taken samples or cytological samples, comprising cells, in view of their subsequent analysis by a cytologist. These cell samples may for example be obtained by pricking with a needle, washing, brushing or collecting urine in a patient. The cells may stem from any organ, for example, the uterus, the liver, the stomach, the breast, etc. A sample of cells may for example be a liquid sample taken, such as urines, ascites, pleural or pericardial liquid; a smear such as a cervical smear, vaginal swab . . . ; a puncture of an organ, for example, a surface gland such as the breast, thyroid, or a deep-lying gland are such as the pancreas or the liver, etc.

By <<cytological fixative>> or <<cytological fixing solution>>, is meant a solution commonly used in cytological analysis for achieving fixing of the cells.

Fixing is an operation intended to preserve the morphology of the cells, as much as possible, in the condition where they were before their being sampled. The best fixatives are those which, while acting rapidly, produce as little as possible any secondary modifications or artefacts which may prevent the analysis of the internal morphology of the cells.

Alcohol formalin acid or AFA is known and has been used for a long time notably in farming and veterinary circles. AFA comprises methyl or ethyl alcohol, formalin and glacial acetic acid. Formalin consists of formic acid, formaldehyde and paraformaldehyde and methanol. An example is the AFA from Locquin, the composition of which is the following:

| | |
|---|---|
| 80° ethyl alcohol | 100 cc, |
| Laboratory 38% formalin | 10 cc, |
| Glacial acetic acid | 5 cc, |
| Saccharose | 10 g, |
| Distilled water | 20 cc. |

Now, glacial acetic acid destroys erythrocytes and lyzes their contents involving very bothersome deposits of hemoglobin in the analysis after standard staining, such as Papanicolaou's stain, or May-Grünwald Giemsa (MGG) staining, or very bothersome for immunocytochemical studies, or other ones. Further, at this concentration, ethyl alcohol is considered from a regulatory perspective, as flammable and formalin as toxic and carcinogenic.

The object of the invention is to provide a fixing solution for biological cells allowing good preservation of the integrity of the nucleated cells and of the erythrocytes in view of their analysis, but nevertheless, less hazardous for the user.

For this purpose, the object of the invention is a fixing solution for biological cells of the aforementioned type, comprising physiological saline in order to avoid osmotic shocks at the wall of the cells, formalin and polyethylene glycol in order to retain the size and the integrity of the fixed nucleated cells and erythrocytes in said solution.

According to other aspects of the invention, the fixing solution for biological cells includes one or several of the following features:
the fixing solution does not comprise any acetone or compounds from the family of ketones or acetic acid, in order to preserve the integrity of the erythrocytes.
the alcohol is ethanol or isopropanol;
the alcohol is a mixture of ethanol and isopropanol;
the amount of alcohol is substantially less than 45% by volume of the fixing solution;
the amount of formalin is substantially comprised between about 0.2 and 1% by volume of the fixing solution.
the fixing solution comprises a buffer guaranteeing a pH of the fixing solution substantially comprised between 6.4 and 7.4; and
the fixing solution comprises between 80% and 95% by volume of:
   590 mL of physiological saline,
   10 mL of PEG (Carbowax®),
   203 mL of isopropyl alcohol,
   193 mL of pure ethanol,
   0.01% by volume of sodium azide,

and between 20% and 5% by volume of 4% buffered formalin.

Thus, this solution allows better retention of the cell proportions, in particular the dimensions of the nucleus relatively to the dimensions of the cell and especially excellent preservation of the erythrocytes.

Further this fixing solution is not very flammable, not toxic and not carcinogenic.

The invention will be better understood upon reading the description which follows, only given as an example and made with reference to the drawings, wherein:

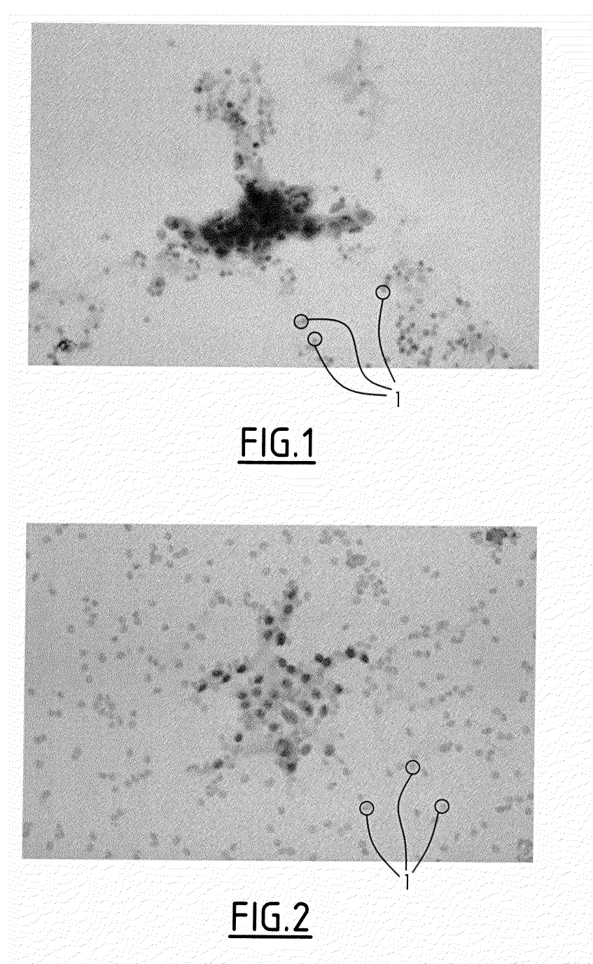

FIG. 1 is a photograph of a sample of cells taken from a breast, said sample being kept in a fixing solution according to the invention,

FIG. 2 is a photograph of cells taken from a thyroid, said sample being kept in a fixing solution according to the invention,

The present invention relates to a fixing solution intended for preserving in vitro a cytological sample, comprising biological cells intended to be analyzed by a cytologist.

The fixing solution comprises an isotonic sodium chloride solute or physiological saline, instead of distilled or deionized water usually used as a base of fixing solutions commonly used.

Physiological saline has been known for a long time and comprises sodium chloride diluted in distilled water, in an amount of 9 grams of sodium chloride for 1 liter of water. Physiological saline is iso-osmolar which maintains the cells in a proper osmolarity condition in order to avoid any osmotic shock thereto at the wall of the cells and therefore destruction of the cells by bursting the cytoplasm and nucleus membranes. The osmolarity of physiological saline is equal to 308 mosmol per liter.

Osmolarity is the concentration of a medium. This resorts to the notion of osmosis, which is the diffusion of a solvent through a semi-permeable membrane which separates two solutions of different concentrations, for example the fixing solution and the cytoplasm liquid of the cells.

Further, the fixing solution includes alcohol for preserving the cells in their condition by fixing them in the alcoholic medium.

Preferably, the amount of alcohol is substantially less than 45% by volume of the fixing solution so as to be not very flammable. Thus, this low alcohol content allows easier transport and storage of the fixing solution as this is less dangerous. By not very flammable is in particular meant that the solution according to the invention does not require the use of the safety pictogram indicating flammability of a product on the package of the solution.

The alcohol is ethanol or isopropanol for example.

According to an alternative, the alcohol is a mixture of ethanol and isopropanol.

However, alcohol alone is a dehydrating and reducing agent thus altering the size of the cells by retraction of the nucleus and of the cytoplasm.

To overcome this drawback, the fixing solution further comprises formalin for retaining the size of the cells, In a known way already published by Saccomanno et al., The fixing solution may also comprise Carbowax® or polyethylene glycol. In a known and already published way, formalin may be associated with decalcification or anti-aggregation agents such as ethylene diamine tetra-acetic acid (EDTA) and its salts. In an also known and already published way, a mucolytic agent such as dithiothreitol (DTT) or acetylcysteine may be added to the samples containing mucus.

With formalin, erythrocytes and nucleated cells may be kept without lyzing them, guaranteeing a reference in terms of size, allowing the cytologist to make a more relevant diagnosis.

In particular, as this may be seen in FIGS. 1 and 2 of cell samples kept in the fixing solution according to the invention, the erythrocytes, referenced as 1 in the figures are perfectly preserved and intact, which gives the possibility of performing a relevant analysis of these samples.

Preferably, the amount of formalin is substantially comprised between about 0.2 and 1% by volume of the fixing solution. At this concentration, formalin or formaldehyde is considered as simply irritating according to the toxicological sheet edited by the French National Research and Safety Institute (Institut National de Recherche et de Sècuritè (INRS)) unlike the generally used concentrations of 1% and 25% at which formalin is corrosive and carcinogenic. Thus, the package of the solution according to the invention does not either require any use of the safety pictogram indicating a corrosive product.

Therefore, at a concentration of less than 1%, the solution may be handled without any risk, the precaution level being lower for handling it.

In a known way, the fixing solution may include an antimicrobial agent.

The fixing solution includes a buffer guaranteeing a pH of the fixing solution substantially comprised between 6.4 and 7.4. This pH range corresponds to optimum conditions for preserving cells and blood of the human body.

The following examples illustrate the invention without limiting the scope thereof.

### EXAMPLE 1

Solution formed with 80% by volume of:
590 mL of physiological saline,
10 mL of PEG (Carbowax®),
203 mL of isopropyl alcohol,
193 mL of pure ethanol,
0.01% by volume of sodium azide,

and with 20% by volume of 4% buffered formalin

Alternatively, the solution may be formed with 90% by volume of the mixture above and with 10% by volume of 4% buffered formalin or with 95% by volume of the mixture above and with 5% by volume of 4% buffered formalin.

It will further be noted that the fixing solution according to the invention does not contain any acetone, all compounds from the family of ketones or acetic acid. Now, these products lyze erythrocytes which, by bursting, release hemoglobin which binds to the cells. Certain types of staining such as Papanicolaou's staining, because of the complexity of the coloring agents associating several nucleus-coloring agents and hemoglobin, then make cytological and notably nuclear analysis very difficult or even impossible. Also, immuno-cyto-chemical analyses are often bothered by a hemoglobin deposits.

According to the invention, subsequent analyses of the sample by Papanicolaou staining or immuno-cyto-chemical studies of the fixed sample in the fixing solution described herein and not containing any acetone or compounds from the family of ketones or acetic acid are improved.

The fixing solution described above therefore allows excellent preservation of the integrity of nucleated cells and of erythrocytes with view to their analysis.

1. A fixing solution intended for preserving in vitro a cytological sample, comprising nucleated cells and erythrocytes, comprising alcohol for fixing the cells, physiological saline in order to avoid osmotic shocks at the wall of the cells, formalin and polyethylene glycol for preserving the size and the integrity of the fixed nucleated cells and erythrocytes in said solution, the fixing solution being characterized in that it does not comprise any acetone or compounds from the family of ketones or acetic acid in order to preserve the integrity of the erythrocytes.

2. The fixing solution according to claim 1, characterized in that the alcohol is ethanol or isopropanol.

3. The fixing solution according to claim 1, characterized in that the alcohol is a mixture of ethanol and of isopropanol.

4. The fixing solution according to claim 1, characterized in that the amount of alcohol is substantially less than 45% by volume of the fixing solution.

5. The fixing solution according to claim 1, characterized in that the amount of formalin is substantially comprised between about 0.2 and 1% by volume of the fixing solution.

6. The fixing solution according to claim 1, characterized in that it comprises a buffer guaranteeing a pH of the fixing solution substantially comprised between 6.4 and 7.4.

7. The fixing solution according to claim 3, characterized in that it comprises between 80% and 95% by volume of:
590 mL of physiological saline,
10 mL of PEG (Carbowax®),
203 mL of isopropyl alcohol,
193 mL of pure ethanol,
0.01% by volume of sodium azide,
and between 20% and 5% by volume of 4% buffered formalin.
